(19) United States
(12) Patent Application Publication
(10) Pub. No.: US 2024/0234797 A9
(43) Pub. Date: Jul. 11, 2024

(54) DENSE GREEN TAPE, METHOD OF MANUFACTURING, AND USE THEREOF

(71) Applicant: CORNING INCORPORATED, CORNING, NY (US)

(72) Inventors: Yinghong Chen, Painted Post, NY (US); Aaron David DeGeorge, Painted Post, NY (US); Zhen Song, Painted Post, NY (US)

(21) Appl. No.: 18/278,025

(22) PCT Filed: Feb. 18, 2022
(86) PCT No.: PCT/US22/16990

§ 371 Date: Aug. 21, 2023

Related U.S. Application Data
(60) Provisional application No. 63/152,033, filed on Feb. 22, 2021.

(51) Int. Cl. H01M 10/0562; H01M 4/38

(52) U.S. Cl. CPC H01M 10/0562; H01M 4/382; H01M 2300/0068

(57) ABSTRACT

A green tape composition includes at least one Li-garnet ceramic powder; at least one excess lithium source; at least one dispersant; at least one binder; and at least one plasticizer, such that a porosity of the green tape composition is <10 vol. %. A method includes dispersing at least one lithium garnet powder and at least one excess lithium source in a predetermined ratio in an organic solvent to form a garnet suspension; adding at least one dispersant, at least one binder, and at least one plasticizer to the garnet suspension; milling the garnet suspension; and de-airing under vacuum, such that a porosity of the green tape composition is <10 vol. %.

### CROSS REFERENCE TO RELATED APPLICATION

This application claims the benefit of priority of International Patent Application Serial No. PCT/US2022/016990 filed on Feb. 18, 2022, which claims the benefit of priority under 35 U.S.C. § 119 of U.S. Provisional Application No. 63/152,033, filed on Feb. 22, 2021, the content of which is relied upon and incorporated herein by reference in its entirety.

### BACKGROUND

### 1. Field

This disclosure relates to lithium-garnet ceramic electrolytes with improved mechanical properties.

### 2. Technical

Lithium-garnet is a promising solid electrolyte candidate in Li metal-based, solid-state, high density batteries. Thin Li-garnet structures are essential for realizing a high volumetric energy density. Conventional methods for making these thin ceramic sheets often result in unwanted reaction between the garnet and at least one of water, CO₂ in air, as well as other components in the slip composition. Thus, traditional methods are not optimal in forming thin Li-garnet sheets from garnet powder.

The present application discloses improved dense green tape, methods of manufacturing, and uses thereof to form lithium-garnet ceramic electrolytes with improved mechanical properties in solid-state lithium metal battery applications.

### SUMMARY

In some embodiments, a green tape composition, comprises: at least one Li-garnet ceramic powder; at least one excess lithium source; at least one dispersant; at least one binder; and at least one plasticizer, wherein a porosity of the green tape composition is <10 vol. %.

In one aspect, which is combinable with any of the other aspects or embodiments, the at least one Li-garnet ceramic powder comprises at least one of: (i) Li₇₋₃ₐLa₃Zr₂LₐO₁₂, with L=Al, Ga or Fe and 0<a<0.33; (ii) Li₇La_{3-b}Zr₂M_{b}O₁₂, with M=Bi, Ca, or Y and 0<b<1; (iii) Li_{7-c}La₃(Zr_{2-c}, N_{c})O₁₂, with N=In, Si, Ge, Sn, Sb, Sc, Ti, Hf, V, W, Te, Nb, Ta, Al, Ga, Fe, Bi, Y, Mg, Ca, or combinations thereof and 0<c<1, or a combination thereof. In one aspect, which is combinable with any of the other aspects or embodiments, the at least one Li-garnet ceramic powder comprises Li_{7-c}La₃(Zr_{2-c}, Ta_{c})O₁₂, and 0<c<1.

In one aspect, which is combinable with any of the other aspects or embodiments, the at least one excess lithium source comprises at least one of: Li₂CO₃, LiGH, Li₂O, LiCl, LiNO₃, Li-citrate, Li-acetate, Li-oleate, LiF, Li₂SO₄, or combinations thereof. In one aspect, which is combinable with any of the other aspects or embodiments, the at least one dispersant comprises at least one of: Disperbyk® 118, Disperbyk® 142, Disperbyk® 182, Disperbyk® 2022, Disperbyk® 2155, Solsperse™ 41090, Anti-Terra® 250, fish oil, or combinations thereof. In one aspect, which is combinable with any of the other aspects or embodiments, the at least one binder comprises at least one of a polyvinyl butyral-based binder or an acrylic binder. In one aspect, which is combinable with any of the other aspects or embodiments, the at least one binder comprises a polyvinyl butyral-based binder. In one aspect, which is combinable with any of the other aspects or embodiments, the at least one binder comprises at least one of Elvacite® 2046, Elvacite® 4044, Butvar® B-79, or combinations thereof. In one aspect, which is combinable with any of the other aspects or embodiments, the at least one plasticizer comprises at least one of: Polymer Innovations® PL029, dibutyl phthalate (DBP), propylene glycol (PG), or combinations thereof.

In one aspect, which is combinable with any of the other aspects or embodiments, the at least one plasticizer is present at a concentration of >13 vol. %. In one aspect, which is combinable with any of the other aspects or embodiments, the at least one Li-garnet ceramic powder comprises pristine Li-garnet ceramic powder. In one aspect, which is combinable with any of the other aspects or embodiments, the at least one Li-garnet ceramic powder comprises passivated Li-garnet ceramic powder.

In one aspect, which is combinable with any of the other aspects or embodiments, a porosity of the green tape composition is <10 vol. %. In one aspect, which is combinable with any of the other aspects or embodiments, a porosity of the green tape composition is <8 vol. %. In one aspect, which is combinable with any of the other aspects or embodiments, a porosity of the green tape composition is <6 vol. %. In one aspect, which is combinable with any of the other aspects or embodiments, a porosity of the green tape composition is <5 vol. %. In one aspect, which is combinable with any of the other aspects or embodiments, the at least one Li-garnet ceramic powder comprises >98 wt. % cubic Li-garnet phase. In one aspect, which is combinable with any of the other aspects or embodiments, a green tape comprising the green tape composition has a bending angle of >90°.

In some embodiments, a method, comprises: dispersing at least one lithium garnet powder and at least one excess lithium source in a predetermined ratio in an organic solvent to form a garnet suspension; adding at least one dispersant, at least one binder, and at least one plasticizer to the garnet suspension; milling the garnet suspension; and de-airing under vacuum, wherein a porosity of the green tape composition is <10 vol. %.

In one aspect, which is combinable with any of the other aspects or embodiments, the at least one lithium garnet powder comprises a passivated Li-garnet ceramic powder. In one aspect, which is combinable with any of the other aspects or embodiments, the at least one lithium garnet powder comprises a non-passivated Li-garnet ceramic powder. In one aspect, which is combinable with any of the other aspects or embodiments, the at least one lithium garnet powder comprises a comprises pristine Li-garnet ceramic powder.

In one aspect, which is combinable with any of the other aspects or embodiments, the at least one lithium garnet powder is heat treated to a temperature of from 700° C. to 1000° C. for a time varying from 30 min to 6 hrs in a dry atmosphere comprising prior to the step of dispersing. In one aspect, which is combinable with any of the other aspects or embodiments, the at least one excess lithium source is heat treated to a temperature of from 700° C. to 1000° C. for a time varying from 30 min to 6 hrs in a dry atmosphere comprising prior to the step of dispersing.

In one aspect, which is combinable with any of the other aspects or embodiments, the at least one excess lithium source comprises at least one of: Li₂CO₃, LiGH, Li₂O, LiCl, LiNO₃, Li-citrate, Li-acetate, Li-oleate, LiF, Li₂SO₄, or combinations thereof. In one aspect, which is combinable with any of the other aspects or embodiments, the at least one dispersant comprises at least one of: Disperbyk® 118, Disperbyk® 142, Disperbyk® 182, Disperbyk® 2022, Disperbyk® 2155, Solsperse™ 41090, Anti-Terra® 250, fish oil, or combinations thereof. In one aspect, which is combinable with any of the other aspects or embodiments, the at least one binder comprises at least one of a polyvinyl butyral-based binder or an acrylic binder. In one aspect, which is combinable with any of the other aspects or embodiments, the at least one binder comprises a polyvinyl butyral-based binder. In one aspect, which is combinable with any of the other aspects or embodiments, the at least one binder comprises at least one of Elvacite® 2046, Elvacite® 4044, Butvar® B-79, or combinations thereof. In one aspect, which is combinable with any of the other aspects or embodiments, the at least one plasticizer comprises at least one of: Polymer Innovations® PL029, dibutyl phthalate (DBP), propylene glycol (PG), or combinations thereof. In one aspect, which is combinable with any of the other aspects or embodiments, the at least one plasticizer is present at a concentration of >13 vol. %.

In one aspect, which is combinable with any of the other aspects or embodiments, the milling is conducted at 500 rpm to 3000 rpm for a time in a range of 1 hr to 5 hrs. In one aspect, which is combinable with any of the other aspects or embodiments, the de-airing is conducted for a time in a range of 1 min to 30 min. In one aspect, which is combinable with any of the other aspects or embodiments, a porosity of the green tape composition is <10 vol. %. In one aspect, which is combinable with any of the other aspects or embodiments, the at least one lithium garnet powder comprises >98 wt. % cubic Li-garnet phase. In one aspect, which is combinable with any of the other aspects or embodiments, the method further comprises sintering a tape cast green tape at a temperature in a range of 900° C. to 1500° C. for a time in a range of 10 sec to 10 min.

In one aspect, which is combinable with any of the other aspects or embodiments, a thickness of the sintered tape cast green tape is <80 μm. In one aspect, which is combinable with any of the other aspects or embodiments, a thickness of the sintered tape cast green tape is <60 μm. In one aspect, which is combinable with any of the other aspects or embodiments, a thickness of the sintered tape cast green tape is <50 μm.

In some embodiments, a battery comprises at least one lithium electrode; and an electrolyte in contact with the at least one lithium electrode, wherein the electrolyte is a lithium-garnet electrolyte comprising a sintered green tape composition described herein.

### BRIEF DESCRIPTION OF THE DRAWINGS

The disclosure will become more fully understood from the following detailed description, taken in conjunction with the accompanying figures, in which:

FIG. 1A illustrates a flexible tape bending 180 degrees without breaking and FIG. 1B illustrates a brittle tape breaking by bending, according to some embodiments.

FIG. 2 illustrates TGA curves of slip composition 2 (passivated garnet powder) and slip composition 9 (as-made garnet powder), according to some embodiments.

FIGS. 3A and 3B illustrate pore size distribution of green tapes formed from slip compositions of Tables 1 and 2, according to some embodiments.

FIG. 4 illustrates tensile strength versus aging time of green tapes formed from slip compositions of Table 2, according to some embodiments.

FIGS. 5A and 5B illustrate flexibility of a green tape aged in ambient air for 25 days and formed from slip composition 12, according to some embodiments.

FIGS. 6A-6D illustrate cross-sectional scanning electron microscopy (SEM) images of sintered green tapes formed from slip compositions of Table 2, according to some embodiments. FIG. 6E illustrates a cross-sectional SEM image of a sintered green tape formed from slip composition 7, according to some embodiments.

FIGS. 7A-7D illustrate cross-sectional SEM images of green tapes formed with 15.1 vol. % porosity (FIG. 7A); 15.1 vol. % porosity after pressing under 50 MPa pressure for 1 hr (FIG. 7B); 3.4 vol. % porosity (FIG. 7C); and 3.4 vol. % porosity after pressing under 50 MPa pressure for 1 hr (FIG. 7D), according to some embodiments.

FIGS. 8A-8D illustrate cross-sectional SEM images of sintered green tapes from FIGS. 7A-7D, according to some embodiments.

FIG. 9 illustrates TGA curves of passivated garnet powder (made by heating at 50° C. for 33 days) and an as-made garnet powder, according to some embodiments.

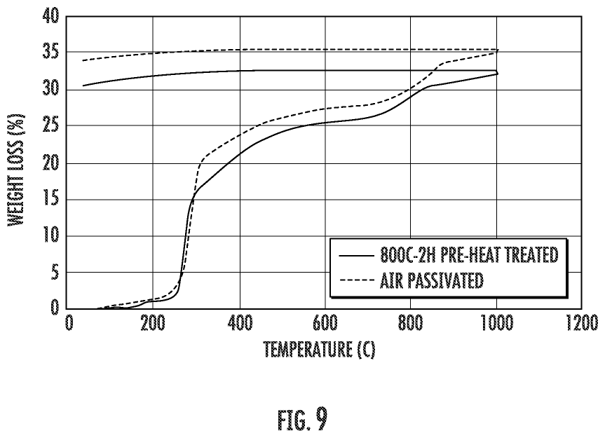

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments. It should be understood that the present application is not limited to the details or methodology set forth in the description or illustrated in the figures. It should also be understood that the terminology is for the purpose of description only and should not be regarded as limiting.

Additionally, any examples set forth in this specification are illustrative, but not limiting, and merely set forth some of the many possible embodiments of the claimed invention. Other suitable modifications and adaptations of the variety of conditions and parameters normally encountered in the field, and which would be apparent to those skilled in the art, are within the spirit and scope of the disclosure.

### Definitions

“LLZO,” “garnet,” or like terms refer to compounds comprising lithium (Li), lanthanum (La), zirconium (Zr), and oxygen (O) elements. Optionally, dopant elements may substitute at least one of Li, La, or Zr.

For example, lithium-garnet electrolyte comprises at least one of: (i) Li₇₋₃ₐ. La₃Zr₂LₐO₁₂, with L=Al, Ga or Fe and 0<a<0.33; (ii) Li₇La_{3-b}Zr₂M_{b}O₁₂, with M=Bi, Ca, or Y and 0<b<1; (iii) Li_{7-c}La₃(Zr_{2-c},N_{c})O₁₂, with N=In, Si, Ge, Sn, V, W, Te, Nb, or Ta and 0<c<1; (iv) Li₇₋ₓLa₃(Zr₂₋ₓ, Mₓ)O₁₂, with M=In, Si, Ge, Sn, Sb, Sc, Ti, Hf, V, W, Te, Nb, Ta, Al, Ga, Fe, Bi, Y, Mg, Ca, or combinations thereof and 0<x<1, or a combination thereof.

“Include,” “includes,” or like terms means encompassing but not limited to, that is, inclusive and not exclusive.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

For example, in modifying the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, “about” or similar terms refer to variations in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” (or similar terms) also encompasses amounts that differ due to aging of a composition or formulation with a particular initial concentration or mixture and amounts that differ due to mixing or processing a composition or formulation with a particular initial concentration or mixture.

As utilized herein, “optional,” “optionally,” or the like are intended to mean that the subsequently described event or circumstance can or cannot occur, and that the description includes instances where the event or circumstance occurs and instances where it does not occur. The indefinite article “a” or “an” and its corresponding definite article “the” as used herein means at least one, or one or more, unless specified otherwise.

As used herein, “room temperature” or “RT” is intended to mean a temperature in a range of about 18° C. to 25° C.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

Abbreviations, which are well known to one of ordinary skill in the art, may be used (e.g., “h” or “hrs” for hour or hours, “g” or “gm” for gram(s), “mL” for milliliters, and “RT” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The compositions, articles, and methods of the disclosure can include any value or any combination of the values, specific values, more specific values, and preferred values described herein, including explicit or implicit intermediate values and ranges.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

As explained above, Li-garnet is a promising solid electrolyte candidate in Li metal-based, solid-state, high density batteries, but often suffers from unwanted reactions between the garnet and at least one of water, CO₂ in air, and other slip composition components during the tape casting process. Tape casting is a conventional process to make ceramic thin sheets. Generally, the process includes mixing inorganic powder(s) (e.g., Li-garnet powders) with tape casting components, such as solvent, dispersant, binder and plasticizer. Resultant green tapes, post-tape casting, have uniformly distributed and bonded inorganic particles in the organic matrices, which comprise pores and allows the inorganic particles to be partially exposed to ambient air.

Li-garnet is active to H₂O and CO₂ in air. The reaction mechanism begins as H₂O decomposes to form H⁺ and OH⁻ on the garnet surface. Thereafter, H⁺ ion-exchanges with Li⁺ in garnet to form H-LLZO garnet, while the Li⁺ further reacts with OH⁻ to form LiOH on the garnet particle surface. The LiOH then reacts with CO₂ in air to form Li₂CO₃. Thus, this series of reactions transforms a pristine garnet particle to one having a core-shell structure, whereby a loose Li₂CO₃ is an outer shell encompassing a H-LLZO inner shell and a Li-garnet center core. This new core-shell structure loosens from the green tape organic matrix (as the formed shell interferes between the bonded Li-garnet and organic matrix), thereby resulting in the green tape aging and becoming brittle and fragile within two weeks.

In the present application, a method is provided to tape cast garnet powder (either active or pristine) whereby a slip composition is developed to allow tape casting of pristine garnet powder with the green tape porosity below at most 10%.

At porosities below 10%, the Li-garnet particles inside the green tape are protected from reacting with ambient air, resulting in green tapes having demonstrated unchanged flexibility, strength and reusability for months. They may also be fire sintered to form dense garnet thin ceramics. In some embodiments, the porosity may be lower than 9.5%, or 9%, or 8.5%, or 8%, or 7.5%, or 7%, or 6.5%, or 6%, or 5.5%, or 5%, or 4.5%, or 4%, or 3.5%, or 3%, or 2.5%, or 2%, or 1.5%, or 1%. At dense green tapes with such porosities (e.g., below 10%) the garnet particles are well sealed by the organic matrix and are prevented from contacting with ambient air.

Active garnet powder is a garnet powder that is at least partially reactive with H₂O and CO₂, but where further reaction is a possibility. For comparison, in a fully passivated garnet powder, the composition does not continue reacting with H₂O and CO₂, and weight gain of the powder, when exposed to air, plateaus. Pristine garnet powder, in one definition, is a garnet powder that is not exposed to H₂O and CO₂. No volatile is contained in the powder. For pristine garnet, the powder has been heat treated to at least 800° C. and is used for making tape casting slip immediately. Some small amount of volatiles may still exist in the powder due to either incomplete desorption or re-adsorption during handling in air.

The following Examples demonstrate making, use, and analysis of the disclosed materials.

### EXAMPLES

### Example 1-Preparation of Li-Garnet Ceramic Powder (Garnet Powder Making)

Step 1: First Mixing Step

In the first mixing step, a stoichiometric amount of inorganic materials is mixed together, in the formula of garnet oxides and, for example, milled into fine powder. The inorganic materials can be a carbonate, a sulfonate, a nitrate, an oxalate, a hydroxide, an oxide, or mixtures thereof with the other elements in the chemical formula. For example, the inorganic materials can be, for example, a lithium compound (e.g., Li₂CO₃) and at least one transition metal compound (e.g., La-based (such as La₂O₃), Zr-based (such as ZrO₂), etc.). In some embodiments, the inorganic materials compounds may also comprise at least one dopant of In, Si, Ge, Sn, Sb, Sc, Ti, Hf, V, W, Te, Nb, Ta, Al, Ga, Fe, Bi, Y, Mg, Ca, or combinations thereof, or oxides thereof (such as Ta₂O₅, WO₃, Ga₂O₃, etc.) in the chemical formula.

In some embodiments, it may be desirable to include an excess of a lithium source material in the starting inorganic batch materials to compensate for the loss of lithium during the high temperature of from 1000° C. to 1300° C. (e.g., 1100° C. to 1200° C.) sintering/second calcining step. The first mixing step can be a dry mixing process (e.g., tubular mixing followed by dry ball milling, or vice versa), dry milling process, or a wet milling process with an appropriate liquid that does not dissolve the inorganic materials. The mixing time, such as from several minutes to several hours, can be adjusted, for example, according to the scale or extent of the observed mixing performance (e.g., 1 min to 48 hrs, or 30 mins to 36 hrs, or 1 hr to 24 hrs (e.g., 12 hrs), or any value or range disclosed therein). The milling can be achieved by, for example, a planetary mill, an attritor, ball mixing, tubular mixing, or like mixing or milling apparatus.

Step 2: First Calcining Step

In the first calcining step, the mixture of inorganic material, after the first mixing step, is calcined at a predetermined temperature, for example, at from 800° C. to 1200° C. (e.g., 950° C.), including intermediate values and ranges, to react and form the target Li-garnet. The predetermined temperature depends on the type of the Li-garnet. The calcination time, for example, varies from 1 hr to 48 hrs (e.g., 2 hrs to 36 hrs, or 3 hrs to 24 hrs, or 4 hrs to 12 hrs (e.g., 5 hrs), or any value or range disclosed therein), and also may depend upon on the relative reaction rates of the selected inorganic starting or source batch materials. In some examples, the predetermined temperature is selected independently from the calcination time, for example, 950° C. for 5 hrs or 1200° C. for 5 hrs. In some embodiments, a pre-mix of inorganic batch materials can be milled and then calcinated or calcined, as needed, in a first step.

Step 3: Second Calcining Step

After the first calcining step, the calcined mixture of inorganic material may be calcined at a higher predetermined temperature for example, at from 1000° C. to 1300° C. (e.g., 1200° C.), including intermediate values and ranges, with a temperature ramping rate (pre-sintering) and cooling rate (post-sintering) ranging from 0.5° C./min to 10° C./min (e.g., 5° C./min). The predetermined temperature for the second calcining depends on the type of the Li-garnet. The calcination time, for example, varies from 1 hr to 48 hrs (e.g., 2 hrs to 36 hrs, or 3 hrs to 24 hrs, or 4 hrs to 12 hrs (e.g., 5 hrs), or any value or range disclosed therein).

In some examples, Steps 2 and 3 may be combined into a single calcining step with two holding phases (the first holding phase represented by Step 2 and the second holding phase represented by Step 3).

Step 4: Milling Step

After the second calcining step, the powder may be milled by ball milling and/or jet milling with 90 wt. % of the above lithium garnet cubic phase. When ball milling is conducted, the ball milled powder is coarser, having a D50 particle size ranging between 1-5 μm. When jet milling is conducted, the jet milled powder is finer, having a D50 particle size ranging between 0.01-1 μm. Both the coarse and fine powders have approximately a bi-modal particle size distribution. For tape casting, a finer powder having a mono-modal distribution is preferred.

Step 5: Sieving Step

The milled powder of Step 4 is then filtered by passing through a 100-grit sieve to obtain a final Li-garnet ceramic powder having a D50 particle size ranging between 0.01-1 μm (e.g., 0.6 μm). Where the powder is formed as an arbitrary shape, the powder may have at least one dimension ranging from 0.01-1 μm.

Step 6: Pristine Garnet Formation

After the sieving step of Step 5, the garnet powder is heat treated to a predetermined temperature of from 700° C. to 1000° C. (e.g., 800° C.) for a time varying from 1 min to 5 hrs (e.g., 30 min to 6 hrs, or 30 min to 3 hrs, or 1 hr to 3 hrs (e.g., 2 hrs), or any value or range disclosed therein) in a dry atmosphere comprising N₂, Ar, O₂/N₂, or O₂/Ar. After the heat treatment, the powder is cooled in the same dry atmosphere, and then utilized for tape casting.

Example 2-Garnet Powder Passivation

In some embodiments, prior to slip preparation (explained in greater detail below), the garnet powder prepared in Example 1 may be air carbonated or acid treated to passivate its high reactivity with other tape casting slip components. This allows the garnet to be stable when tape casting the slip and as a result, the final green tape may be stable for extended periods of time.

Garnet Powder Passivation by Air Carbonation

As-made garnet powder (of Example 1) is exposed to air at 50° C. for 1 month. The powder reacts with H₂O and CO₂ in air to form H-LLZO (inner core; H-doped LLZO), with an overlaying Li₂CO₃ outer shell on the garnet powder particles. As stated above, this passivates garnet to prevent garnet reaction with organic components in the slip composition and when tape casting the slips.

Garnet Powder Passivation by Acid Treatment

In an alternate passivation technique, acid (e.g., HCl, HF, HNO₃, H₃PO₄, H₂SO₄, acetic acid, boric acid, carbonic acid, citric acid, oxalic acid, etc.) is added to a slurry of the as-made garnet powder (of Example 1). Initially, pH of the slurry exceeds 7, but this value gradually decreases by addition of the acid until settling to a desired pH of around 6. Centrifuging the slurry separates the final powder. The obtained testing powder is H-LLZO (protonated garnet) (i.e., no outer Li₂CO₃ shell formation-one composition of protonated garnet) that is stable with the tape casting slip.

### Example 3-Preparation Excess Li Source

An excess Li source may be used in preparing the slip compositions (detailed below) to compensate for Li loss during tape sintering (Example 5). In some examples, prior to utilizing, the excess Li source may be heat treated to a predetermined temperature of from 700° C. to 1000° C. (e.g., 800° C.) for a time varying from 1 min to 5 hrs (e.g., 30 min to 6 hrs, or 30 min to 3 hrs, or 1 hr to 3 hrs (e.g., 2 hrs), or any value or range disclosed therein) in a dry atmosphere comprising N₂, Ar, O₂/N₂, or O₂/Ar. After the heat treatment, the powder is cooled in the same dry atmosphere. In some examples, the excess Li of the slip composition formulation may be selected from the group comprising: Li₂CO₃, LiGH, Li₂O, LiCl, LiNO₃, Li-citrate, Li-acetate, Li-oleate, LiF, Li₂SO₄, or combinations thereof. In slip compositions where the excess Li source is prepared as in Example 3, the garnet powder and excess Li source may be mixed first, and then heat treated together or, each may be heat treated separately and then mixed thereafter.

### Example 4-Slip Making

In embodiments, tape casting involves mixing inorganic powder(s) (e.g., garnet, such as that prepared in Example 1 or Example 2) with tape casting components, such as solvent, dispersant, binder, plasticizer, and an excess lithium source (e.g., LiCO₃) to form a slip composition. The garnet composition may be any as defined herein (e.g., Ta-LLZO garnet powder). Exemplary slip composition formulations are listed in Table 1, though the slip composition components may be varied for achieving a variety of high-quality green tapes without departing from the nature of the application.

TABLE 1

| Slip Composition No. | 1 | 2 | 3 | 4 | 5 | 6 | 7 | 8 |
|---|---|---|---|---|---|---|---|---|
| Passivated garnet | 100:5.5 | | | | | | | |
| powder (from Ex. 2)-to- | | | | | | | | |
| excess Li source ratio | | | | | | | | |
| | | | | | | | Disperbyk ® | |
| | Disperbyk ® 2155 (D2155) | | | | | | 118 (D118) | Fish oil |
| Dispersant (wt. %) | 6.08 | 5.98 | 6.23 | 5.98 | 6.96 | 6.05 | 7.01 | 7.12 |
| Binder (Elvacite ® 2046) | 26.88 | 27.53 | 27.82 | 27.53 | 27.08 | 28.21 | 28.13 | 27.89 |
| (wt. %) | | | | | | | | |
| | Polymer Innovations ® | | | | | | | |
| | PL029 | | | Dibutyl phthalate (DBP) | | | | |
| Plasticizer (wt. %) | 13.95 | 14.29 | 13.86 | 14.29 | 12.42 | 12.94 | 12.63 | 12.80 |

Garnet green tape:

| | | | | | | | | |
|---|---|---|---|---|---|---|---|---|
| Porosity (vol. %) | 10.29 | 7.75 | 10.10 | 13.19 | 15.12 | 12.18 | 22.13 | 18.05 |
| Solid vol. % | 53.09 | 52.20 | 52.08 | 52.20 | 53.54 | 52.80 | 52.24 | 52.20 |

In some examples, the excess Li of the slip composition formulation may be selected from the group comprising: Li₂CO₃, LiGH, Li₂O, LiCl, LiNO₃, Li-citrate, Li-acetate, Li-oleate, LiF, Li₂SO₄, or combinations thereof. In some examples, the dispersant of the slip composition formulation may be selected from the group comprising: Disperbyk® 118, Disperbyk® 142, Disperbyk® 182, Disperbyk® 2022, Disperbyk® 2155, Solsperse™ 41090, Anti-Terra® 250, fish oil, or combinations thereof. In some examples, the binder of the slip composition formulation may be selected from the group comprising: Elvacite® 2046, Elvacite® 4044, Butvar® B-79, or combinations thereof. In some examples, the plasticizer of the slip composition formulation may be selected from the group comprising: Polymer Innovations® PL029, dibutyl phthalate (DBP), propylene glycol (PG), or combinations thereof.

Exemplary slip composition formulations are also listed in Table 2, though the slip composition components may be varied for achieving a variety of high-quality green tapes without departing from the nature of the application.

TABLE 2

| Slip Composition No. | 2 | 9 | 10 | 11 | 12 |
|---|---|---|---|---|---|
| Garnet Powder | Ex. 1, steps | Ex. 1, steps | Ex. 1, steps | Ex. 1, steps | Ex. 1, steps |
| Preparation | 1-5 + Ex. 2 | 1-5 | 1-6 | 1-6 | 1-6 |
| Garnet Powder | Yes | No | No | No | No |
| Passivated? | | | | | |
| Excess Li Source | — | — | — | Ex. 3 | Ex. 3 |
| Preparation | | | | | |
| Garnet powder-to- | 100:5.5 | | | | |
| excess Li source ratio | | | | | |
| Dispersant (D2155) | 5.98 | 6.54 | 7.10 | 7.42 | 7.10 |
| (wt. %) | | | | | |
| Binder | Elvacite ® 2046 | Elvacite ® 2046 | Elvacite ® 4044 | Elvacite ® 2046 | Elvacite ® 4044 |
| (wt. %) | 27.53 | 30.12 | 32.68 | 34.16 | 32.68 |
| Plasticizer (PL029) | 14.29 | 15.63 | 16.69 | 17.73 | 16.69 |
| (wt. %) | | | | | |

Garnet green tape:

| | | | | | |
|---|---|---|---|---|---|
| Porosity (vol. %) | 7.75 | 3.38 | 4.52 | 3.28 | 4.52 |
| Solid vol. % | 52.20 | 47.70 | 43.25 | 40.70 | 43.25 |

Slip making includes steps of dispersing the lithium garnet powder and excess lithium source in a predetermined ratio in an organic solvent (e.g., 2:1 wt. % ethanol-to-butanol, 2:1 wt. % n-propyl propionate-to-n-Butyl propionate, etc.) to form a garnet suspension. From Table 2, slip composition 2 is prepared with the lithium garnet powder as in Example 1, steps 1-5 and then passivated as in Example 2. Slip composition 9 is prepared with the lithium garnet powder as in Example 1, steps 1-5, but without passivating. Slip composition 10 is prepared with the lithium garnet powder as in Example 1, steps 1-6 (pristine garnet), but without passivating. Slip compositions 11 and 12 are prepared with the lithium garnet powder as in Example 1, steps 1-6 (pristine garnet), but without passivating, and the excess lithium source is treated as in Example 3. Thereafter, the dispersant, binder, and plasticizer are added to the garnet suspension (e.g., such as in Tables 1 and 2), milled (e.g., attrition milling at 500-3000 rpm (e.g., 2000 rpm) for 1-5 hrs (e.g., 2 hrs)) and de-aired under vacuum for 1 to 30 min. In some embodiments, the milling and mixing may be conducted under vacuum and chilling to prevent inadvertent reaction between the garnet and other slip components.

### Example 5-Tape Casting and Sintering

The tape casting process includes, for example, slip making (described above), tape casting, and drying (sintering, described below). Tape casting may be conducted using a 6 mil to 18 mil blade, for example.

Garnet tapes were sintered in both air and argon (Ar) atmosphere. During sintering, green tapes were carried on a setter (e.g., alumina, MgO, ZrO₂, grafoil) or suspended in air. When a setter is used, the green garnet tapes may be sandwiched in between setter sheets to retain lithium. No mother powder is needed. Two types of sintering methods may be used: conventional sintering and fast sintering. In conventional sintering, the temperature ramping rate is in a range of 100° C./hr to 600° C./hr. In fast sintering, the temperature ramping rate is in a range of 100° C./min to 1000° C./min. Li-loss in fast sintering is significantly reduced and as a result, green tapes may be sintered in ambient air without any covering. To prevent thermal shock, the setters are preferred in thin film form (ceramic thin sheet or ceramic ribbon). For conventional sintering, an Ar or nitrogen (N₂) atmosphere is preferred.

In some examples, the tape cast green tape may be sintered in air with a temperature ramping speed of in a range of 250° C./hr to 500° C./hr (e.g., 400° C./hr) to temperatures in a range of 900° C. to 1500° C. (e.g., 1200° C.) for a time in a range of 10 sec to 10 min (e.g., 3 min). The slip is cast with good uniformity, surface smoothness, and tape reliability after drying.

### Example 6-Characterization

Tape Porosity

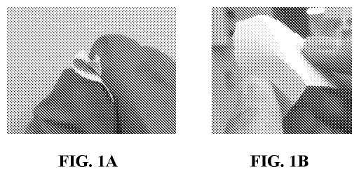

Tables 1 and 2 show garnet green tape porosity percentage for each slip composition. As used herein, the term “porosity” is described as a percent by volume (e.g., at least 10 vol. %, or at least 30 vol. %), where the “porosity” refers to portions of the volume of the green tape unoccupied by inorganic material. When green tape porosity exceeds approximately 10 vol. %, and especially exceeding 15 vol. %, the tape becomes brittle within a few weeks (e.g., 1-4 weeks). As used herein, “brittle” may be defined as when the tape is not bendable or if it has a bending angle of <90°. FIG. 1A illustrates a flexible tape bending 180 degrees without breaking and FIG. 1B illustrates a brittle tape breaking by bending. All green tape components (i.e., those included in the slip composition) have an impact on green tape pore formation. For example, lower solid loading may lead to decreased porosity. Additionally, for example, when plasticizer is increased, porosity may decrease by both chemical and physical means. The plasticizer may also alter binder properties (making it softer) in the green tape.

Green tape porosity was measured using Hg porosimetry using a Micromeritics Autopore IV 9520, a 60,000 psia Hg porosimeter covering a pore diameter range from 360 to 0.003 μm. Volume distribution of pores in solid and powder materials are measured by mercury intrusion. Each unit has four low pressure ports (0.5 to 30 psia) and two high pressure (30 to 60,000 psia) chambers. All aspects of low pressure and high-pressure analysis, as well as data collection, reduction, and display are processed by a control module. Green tape material is rolled up, weighed, then placed into a sealed 5 cc penetrometer then loaded into the Autopore. After pumped vacuum, the penetrometer is backfilled with Hg and pressurized to specific pressure points reaching a maximum pressure of 60,000 psi. In Table 1, slip composition 2 exhibited the lowest porosity at 7.75 vol. %, at least in part due to utilization of PL029 plasticizer in a quantity exceeding at least 13 wt. % in the green tapes. The green tape formed from slip composition 2 has a porosity lower than 10% (7.75%) while green tapes formed from slip compositions 1 and 3 have porosities >10% because the solids in these slips were degassed (i.e., heat treated), resulting in a decreased vol. % of solids but and increased density of the solid. The garnet mol. % in all of slip compositions 1-3 are the same.

For green tapes formed from the slip compositions of Table 1, a pore size distribution for the pores were in a range of mostly between 0.1 μm to 1 μm, though some fine pores were also observed at sizes less than 0.05 μm. It is mostly between the pore sizes of 0.1 μm to 1 μm where discernible differences are seen for green tapes produced with slip compositions of Table 1. In other words, none of the green tapes had measurable pores having sizes below about 0.1 μm and above about 1 μm, with the exception of a small selection of fine pores around 0.05 μm. As a whole, slip composition 2 had the smallest total pore volume percentage (7.75 vol. %), while slip compositions 5, 7, and 8 had among the highest total pore volume percentage, with each exceeding 15 vol. %.

Table 2 uses a base condition of slip composition 2 and alters treatments to the lithium garnet powder and/or excess lithium source prior to dispersing in the organic solvent to form a garnet suspension and then mixing with the dispersant, binder, and plasticizer. These are summarized in Table 3.

TABLE 3

| | Slip Compositions | | | | |
|---|---|---|---|---|---|
| Step | 2 | 9 | 10 | 11 | 12 |
| 1. Garnet Powder | Not pristine garnet, | Not pristine garnet, | Pristine garnet (800° C., 2 hrs), not passivated | | |
| Preparation | passivated | not passivated | | | |
| 2. Excess Li Source | — | — | — | 800° C., 2 hrs | 800° C., 2 hrs |
| Preparation | | | | | |

3. Dispersing garnet powder and excess lithium source in solvent to form suspension
4. Adding dispersant (D2155), plasticizer (PL029), and binder (below) to garnet suspension

| | | | | |
|---|---|---|---|---|
| Elvacite ® 2046 | Elvacite ® 2046 | Elvacite ® 4044 | Elvacite ® 2046 | Elvacite ® 4044 |

5. Milling the garnet suspension & de-airing under vacuum

Thus, to test the effects of garnet powder passivation (Example 2), garnet powder heat treatment (Example 1, step 6), and excess Li source heat treatment (Example 3), slip composition 2 is used as a base for preparation of slip compositions 9-12, which are then tape cast (Example 5) and characterized. Slip compositions 2, 9-12 all contain equivalent mole quantities of garnet, but the powder is treated differently, thereby resulting in garnet powders having varying densities, p: passivated garnet powder of composition 2, ρ˜4.0 g/cm³, as-made garnet of composition 9, ρ˜4.4 g/cm³, pristine garnet after 800° C., 2 hrs heat treatment of compositions 10-12, ρ˜5.18 g/cm³. Garnet powders having varying densities affects final porosity because since different density solids have different volumes-resulting in varying solid vol. % in the green tapes (see Table 2)—this leads to varying porosities.

The excess Li source may be added concurrently or sequentially with the garnet powder into the organic solvent in preparing the slip composition. For example, in slip compositions 11 and 12, the garnet powder may be mixed with the excess Li source, and then the combined mixture heat treated at 800° C. for 2 hrs, or each of the garnet powder and excess Li source may be separately heat treated at 800° C. for 2 hrs and then combined in the organic solvent.

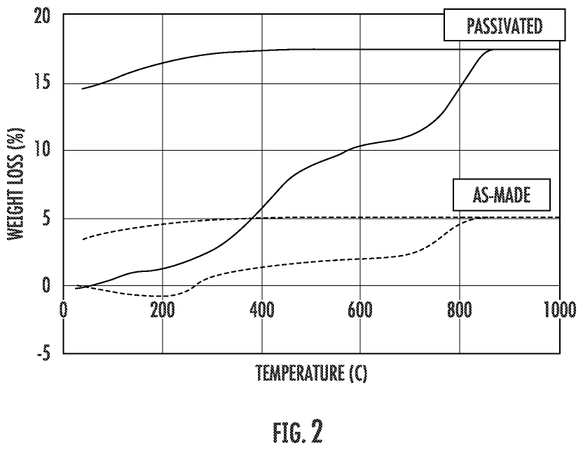

Thermogravimetric analysis (TGA) may be used to determine a material's thermal stability and its fraction of volatile components by monitoring weight change that occurs as a sample is heated at a constant rate using a LECO TGA 701 by LECO Corporation. In measurement, the powder is heated from room temperature to 1000° C. at a temperature ramping speed of 2° C./min. FIG. 2 illustrates TGA curves of passivated garnet powder (made by heating at 50° C. for 33 days and used in slip composition 2) and an as-made garnet powder (used in slip composition 9). Because the garnet in slip composition 9 is exposed to air during powder handling, it contains about 5 wt. % volatiles (weight loss) while slip composition 2, which has been exposed to ambient air for more than a month, has a TGA weight loss of about 17 wt. %. The excess amount of Li source added into each of these slips is the same. The difference in quantity of volatiles for the garnet powder in slip compositions 2 and 9 also reflect their density differences (ρ˜4.0 g/cm³ for passivated garnet powder and ρ˜4.4 g/cm³ for as-made garnet), which translates into different quantities of adsorbed water and CO₂ in air to form H-LLZO, LiGH, and Li₂CO₃ in the garnet powder, as explained above. For the same mole amount of garnet, the solid volume percentage for the as-made powder in slip composition 9 is lower than the passivated powder in slip composition 2. Therefore, for the same given organic binder matrices, slip composition 2 versus slip composition 9 has increased porosity of the corresponding green tapes (7.75 vol. % for slip composition 2 containing passivated garnet powder versus 3.38 vol. % for slip composition 9 containing as-made garnet powder).

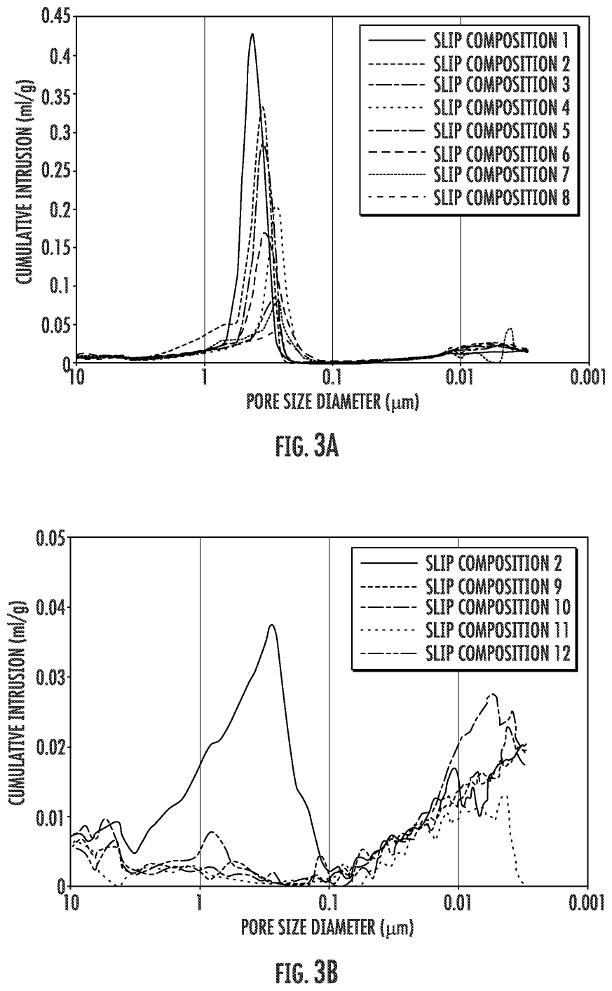

FIGS. 3A and 3B illustrate pore size distribution of green tapes formed from slip compositions of Tables 1 and 2. Pore volume (i.e., area under the curves) of the tapes in Table 1 are much larger than those in Table 2. Two peaks are observed for tapes in Table 1 (FIG. 3A), one corresponding to pores having a pore size distribution in a range of mostly between 0.1 μm to 1 μm; and one corresponding to pores having a pore size distribution of less than 0.05 μm. As slip composition varies, so does the peak position for the 0.1 μm to 1 μm pore size distribution range; the peak position for the <0.05 μm pore size distribution range does not. This indicates that pores in the 0.1 μm to 1 μm range distribution are from polymer particle packing in the green tapes, while pores in the <0.05 μm range distribution may be from intrinsic pores of the binder/plasticizer system. The green tape formed from slip composition 2 has the smallest peak at the 0.1 μm to 1 μm distribution range in FIG. 3A. FIG. 3B shows the zoomed in pore size distribution curves for slip composition 2 tapes, together with green tapes formed from slip compositions 9-12 (as-made (i.e., less passivated) and pre-heat-treated garnet powders). The tapes formed from slip compositions 9-12 show nearly no peaks at the 0.1 μm to 1 μm pore size distribution range. This indicates that the green tape is fully dense from the polymer/solid matrices.

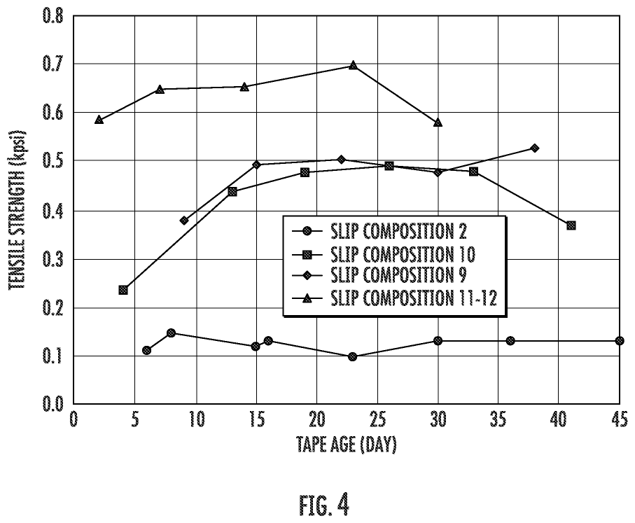

FIG. 4 illustrates tensile strength versus aging time of green tapes formed from slip compositions of Table 2. All green tapes were casted and stored in ambient air. The tape tensile strength was measured by pulling a strip of 1.5 cm×12 cm green tape using a SHIMPO FVG-10XY. Three trials were conducted to obtain an average value for each tape at various aging times. Multiple measurements were obtained over an aging period of about 40 days. Green tapes formed from slip compositions 9-12 (sub-5 vol. % porosity) had a higher tensile strength (lower porous defects) at each aging period than slip composition 2 (7.75 vol. % porosity).

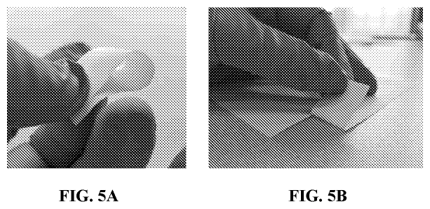

FIGS. 5A and 5B illustrate flexibility of a green tape aged in ambient air for 25 days and formed from slip composition 12, which is, among those compositions of Table 2, containing the most reactive garnet powder to air. Porous green tapes made from highly reactive garnet powder leads to low flexibility, as the resultant tapes becomes brittle within a few days, as seen in also in FIG. 1B. All tapes formed from slip compositions 2 and 9-12 remain flexible and may be easily released from carrier films supporting the green tape after tape casting and exposing to reactive air conditions for several months or even more than one year. Each of the green tapes from Table 2 (having a porosity less than approximately 10 vol. %) are flexible, bending 180 degrees without breaking.

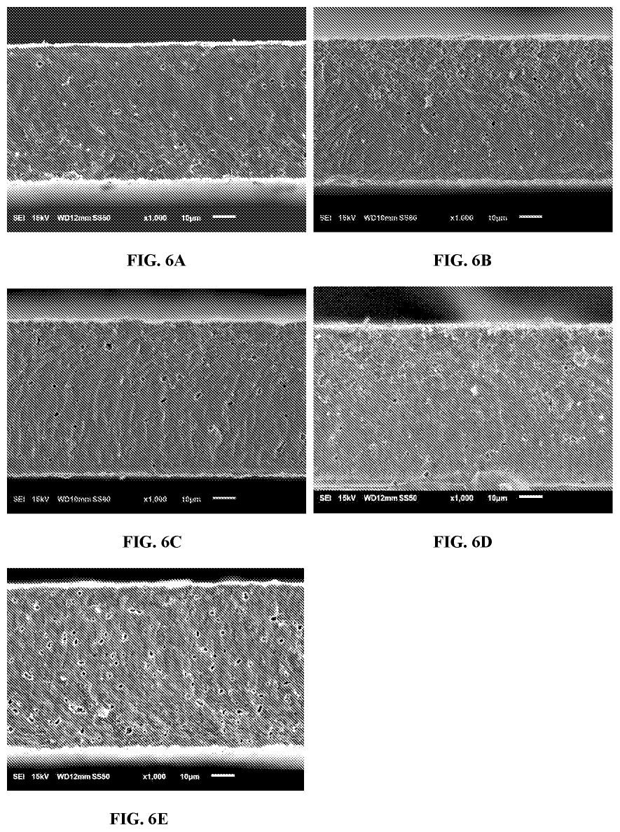

FIGS. 6A-6D illustrate scanning electron microscopy (SEM) images of sintered green tapes formed from slip compositions of Table 2. Scanning electron microscopy (SEM) images were obtained by a scanning electron microscope (JEOL, JSM-6010PLUS/LA). FIGS. 6A-6D are fractured cross sections of green tapes formed from slip composition 2 (FIG. 6A), slip composition 9 (FIG. 6B), slip composition 10 (FIG. 6C), and slip compositions 11 and 12 (FIG. 6D). All sintered green tapes have a dense microstructure, which is indicative of low porosity materials. In conventional tape casting studies, solid loading in green tape is increased from slip calculation for achieving high sintered ceramics density. As shown in Table 2, fully dense green tapes 9-12 (i.e., minimal pores with a size distribution of between 0.1 μm to 1 μm) have lower solid loading (˜47-48 vol. %), however the sintered microstructure is at least as dense as the higher solid loading tape formed from slip composition 2, which has higher solid loading (52.2 vol. %) and also some small number of pores in the green tape (total porosity of 7.75%). For comparison, FIG. 6E shows a cross section SEM image of a sintered tape made from slip composition 7 in Table 1 (solid loading 52.2 vol. %, green tape porosity 22.1%). Many more pores are observed in sintered tapes.

Table 4 describes XRD-measured compositional analysis of sintered green tapes formed from the slip compositions of Table 2. X-ray powder diffraction (XRD) patterns were obtained by x-ray powder diffraction (Bruker, D4, Cu-Kα radiation, λ=1.5415 Å) in the 2θ range of 10-80° at room temperature. Li-ion conductivity of the samples were measured by AC impedance analysis (Solartron SI 1287) with a frequency range of 0.1 Hz to 1 MHz. Results are shown in Table 4.

TABLE 4

| Slip | Li-ion conductivity | |
|---|---|---|
| Composition | (S/cm) | XRD Pattern |
| 2 | 4.24 × 10⁻⁴ | 99 wt. % cubic garnet |
| | | 1 wt. % La₂Zr₂O₇ |
| 9 | 5.38 × 10⁻⁴ | 99.3 wt. % cubic garnet |
| | | 0.3 wt. % La₂Zr₂O₇ |
| | | 0.4 wt. % La₂O₃ |
| 10 | 4.98 × 10⁻⁴ | 99.4 wt. % cubic garnet |
| | | 0.6 wt. % La₂O₃ |
| 11 | 5.41 × 10⁻⁴ | 98.7 wt. % cubic garnet |
| | | 0.7 wt. % La₂Zr₂O₇ |
| | | 0.6 wt. % La₂O₃ |
| 12 | 5.32 × 10⁻⁴ | 99.5 wt. % cubic garnet |
| | | 0.5 wt. % La₂O₃ |

All samples in Table 4 have high concentrations of cubic garnet phase (e.g., >98 wt. %). A high cubic phase ensures a high ionic conductivity (˜5×10⁻⁴ S/cm), which is beneficial for lithium-garnet solid electrolytes in Li metal-based, solid-state, high density batteries. The presence of La₂Zr₂O₇ and/or La₂O₃ are auxiliary products of garnet decomposition. These auxiliary products appear as large agglomerates (multiple garnet grains size) and pores in the sintered tapes. An excess of the auxiliary products leads to conductivity decreases and weaker tape strength. In the case of Table 4, very low concentrations of auxiliary products are measured (less than 1.5 wt. %). Large quantities of auxiliary products may be one indication of Li loss during tape sintering and not enough excess Li to recuperate the loss.

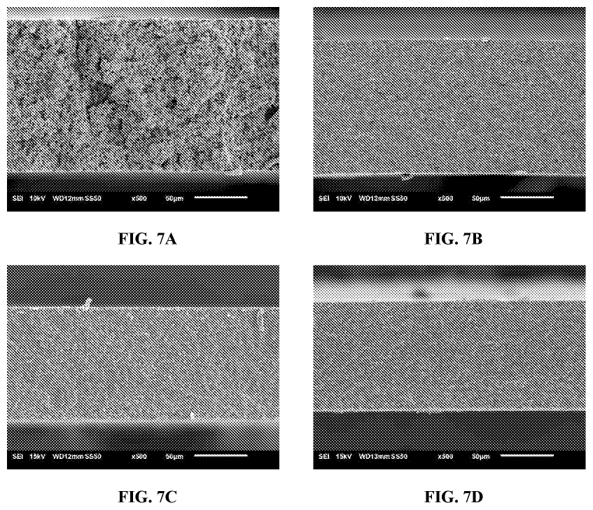

FIGS. 7A-7D illustrate cross-sectional SEM images of green tapes formed with: slip composition 5, which has 15.1 vol. % porosity (FIG. 7A); slip composition 5 after pressing under 20 MPa pressure for 1 hr (FIG. 7B); slip composition 9, which has 3.4 vol. % porosity (FIG. 7C); and slip composition 9 after pressing under 20 MPa pressure for 1 hr (FIG. 7D). FIGS. 7A and 7B are cross-sectional SEM images of porous green tapes, while FIGS. 7C and 7D are cross-sectional SEM images of non-porous green tapes. This is observed by the level of densification that occurs in the 15.1 vol. % porosity green tape after pressing versus the level of densification that occurs in the 3.4 vol. % porosity green tape after pressing. Significant densification of the 15.1 vol. % porosity green tape is seen after pressing and is accompanied by an observable tape thickness decrease. No obvious tape structure and thickness change is observed for the 3.4 vol. % porosity green tape.

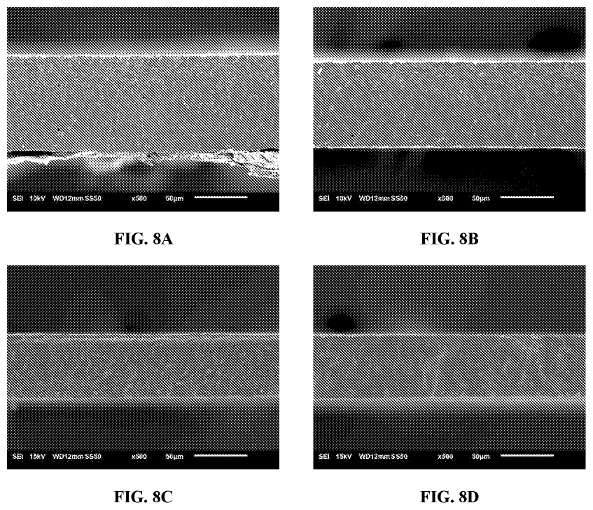

FIGS. 8A-8D illustrate cross-sectional SEM images of sintered green tapes from FIGS. 7A-7D. As seen in FIGS. 8A and 8B, from the same 15.1 vol. % porosity, with pressing (FIG. 8B) and without pressing (FIG. 8A), the green tapes sinter to different thicknesses, indicating that the thicker tape (FIG. 8A) contains more pores than the thinner tape (FIG. 8B). From FIGS. 8C and 8D, from the same 3.4 vol. % porosity, with pressing (FIG. 8D) and without pressing (FIG. 8C), the green tapes sinter to relatively equivalent thicknesses, indicating that the densities of the sintered tapes (with and without pressing the green tapes) are about the same. Pressing to densify green tapes is often used before sintering to increase sintering density. A low porosity tape eliminates the need for green tape pressing processes to achieve increased sintering density. The green tape formed from slip composition 5, although having high porosity, has the highest solid loading. This allows this tape to be able to sinter dense. However, due to a high solid loading, the green tape strength is very low (<0.05 kpsi), which results in high firing cracks.

Thus, as presented herein, this disclosure relates to improved dense green tape, methods of manufacturing, and uses thereof to form lithium-garnet ceramic electrolytes with improved mechanical properties in solid-state lithium metal battery applications.

It will be apparent to those skilled in the art that various modifications and variations can be made without departing from the spirit or scope of the claimed subject matter. Accordingly, the claimed subject matter is not to be restricted except in light of the attached claims and their equivalents.

What is claimed is:

1. A green tape composition, comprising:
at least one Li-garnet ceramic powder;
at least one excess lithium source;
at least one dispersant;
at least one binder; and
at least one plasticizer,
wherein a porosity of the green tape composition is <less than 10 vol. %.

2. The green tape composition of claim 1, wherein the at least one Li-garnet ceramic powder comprises at least one of:
(i) Li₇₋₃ₐLa₃Zr₂LₐO₁₂, with L=Al, Ga or Fe and 0<a<0.33;
(ii) Li₇La_{3-b}Zr₂M_{b}O₁₂, with M=Bi, Ca, or Y and 0<b<1;
(iii) Li_{7-c}La₃(Zr_{2-c}, N_{c})O₁₂, with N=In, Si, Ge, Sn, Sb, Sc, Ti, Hf, V, W, Te, Nb, Ta, Al, Ga, Fe, Bi, Y, Mg, Ca, or combinations thereof and 0<c<1, or a combination thereof.

3. The green tape composition of claim 2, wherein the at least one Li-garnet ceramic powder comprises Li_{7-c}La₃(Zr_{2-c}, Ta_{c})O₁₂, and 0<c<1.

4-5. (canceled)

6. The green tape composition of claim 1, wherein the at least one binder comprises at least one of a polyvinyl butyral-based binder or an acrylic binder.

7-8. (canceled)

9. The green tape composition of claim 1, wherein the at least one plasticizer comprises at least one of Polymer Innovations® PL029, dibutyl phthalate (DBP), propylene glycol (PG), or combinations thereof.

10. The green tape composition of claim 1, wherein the at least one plasticizer is present at a concentration of >greater than 13 vol. %.

11. The green tape composition of claim 1, wherein the at least one Li-garnet ceramic powder comprises pristine Li-garnet ceramic powder.

12. The green tape composition of claim 1, wherein the at least one Li-garnet ceramic powder comprises passivated Li-garnet ceramic powder.

13. (canceled)

14. The green tape composition of claim 1, wherein a porosity of the green tape composition is <less than 8 vol. %.

15. The green tape composition of claim 1, wherein a porosity of the green tape composition is <less than 6 vol. %.

16-17. (canceled)

18. The green tape composition of claim 1, wherein a green tape comprising the green tape composition has a bending angle of >greater than 90°.

19. A method, comprising:
dispersing at least one lithium garnet powder and at least one excess lithium source in a predetermined ratio in an organic solvent to form a garnet suspension;
adding at least one dispersant, at least one binder, and at least one plasticizer to the garnet suspension;
milling the garnet suspension; and
de-airing under vacuum,
wherein a porosity of the green tape composition is <less than 10 vol. %.

20. The method of claim 19, wherein the at least one lithium garnet powder comprises a passivated Li-garnet ceramic powder.

21. (canceled)

22. The method of claim 19, wherein the at least one lithium garnet powder comprises a comprises pristine Li-garnet ceramic powder.

23. The method of claim 19, wherein the at least one lithium garnet powder is heat treated to a temperature of from 700° C. to 1000° C. for a time varying from 30 minutes to 6 hours in a dry atmosphere comprising prior to the step of dispersing.

24. The method of claim 19, wherein the at least one excess lithium source is heat treated to a temperature of from 700° C. to 1000° C. for a time varying from 30 minutes to 6 hours in a dry atmosphere comprising prior to the step of dispersing.

25-26. (canceled)

27. The method of claim 19, wherein the at least one binder comprises at least one of a polyvinyl butyral-based binder or an acrylic binder.

28-30. (canceled)

31. The method of claim 19, wherein the at least one plasticizer is present at a concentration of >greater than 13 vol. %.

32-35. (canceled)

36. The method of claim 19, further comprising:
sintering a tape cast green tape at a temperature in a range of 900° C. to 1500° C. for a time in a range of 10 seconds to 10 minutes.

37-39. (canceled)

40. A battery, comprising:
at least one lithium electrode; and
an electrolyte in contact with the at least one lithium electrode, wherein the electrolyte is a lithium-garnet electrolyte comprising a sintered green tape composition of claim 1.
